(19) United States
(12) Patent Application Publication
(10) Pub. No.: US 2025/0164978 A1
(43) Pub. Date: May 22, 2025

(54) GENERATING CONTEXTUALLY GROUNDED RECOMMENDATIONS USING A LARGE LANGUAGE MODEL

(71) Applicant: Adobe Inc., San Jose, CA (US)

(72) Inventors: Siddarth Ramesh, Noida (IN); Tarun Arora, New Delhi (IN); Tanay Anand, Uttar Pradesh (IN); Shreeya Singh, Telangana (IN); Md Anis Alam, Uttar Pradesh (IN); Jayakumar Subramanian, Uttar Pradesh (IN); Avinash Katiyar, Gurugram, Haryana (IN)

(21) Appl. No.: 18/513,466

(22) Filed: Nov. 17, 2023

(51) Int. Cl. G05B 19/418

(52) U.S. Cl. CPC G05B 19/41885; G05B 2219/13023; G05B 2219/13038

(57) ABSTRACT

Certain aspects and features of the present disclosure relate to providing contextually grounded recommendations using a large language model. For example, a method involves receiving domain specific data for a simulation and transforming the domain specific data into a labeled, natural language description of the domain specific data. The method also involves providing the labeled, natural language description and a classification task prompt with interaction history to a large language model (LLM) to generate a contextually enhanced LLM configured to produce context-aware output. The method further involves outputting, using the contextually enhanced LLM, an interactive list of scored actions corresponding to the simulation. The interactive list can be used to produce a sequence of actions to direct a process or control a machine.

### TECHNICAL FIELD

The present disclosure generally relates to automatically producing recommended actions for a system. The recommended actions are based on modeling the behavior of the system. More specifically, but not by way of limitation, the present disclosure relates to machine-learning based techniques for programmatically determining sequences of actions from the recommended actions to provide higher likelihoods of success in operating the system.

### BACKGROUND

Users of complex systems such as those connected with managing a business, service, controlling robots or other manufacturing systems, as well as software, climatological, medical, or other scientific endeavors, need focus their efforts on the most valuable opportunities. To achieve this, users might rely on extensive research in order to craft effective strategies and develop a sequence of actions to carry out those strategies. To apply this research, users analyze available data, either manually or with statistical tools. Success can be achieved, in some cases with some trial and error, by personnel who have developed a high level of expertise and competence through extensive training and experience with the tools and techniques available.

### SUMMARY

Certain aspects and features of the present disclosure relate to providing contextually grounded recommendations using a large language model. For example, a method involves receiving domain specific data for a simulation and transforming the domain specific data into a labeled, natural language description of the domain specific data. The method also involves providing the labeled, natural language description and a classification task prompt with interaction history to a large language model (LLM) to generate a contextually enhanced LLM configured to produce context-aware output. The method further involves outputting, using the contextually enhanced LLM, an interactive list of scored actions corresponding to the simulation. The list can be used to generate a sequence of actions.

Other embodiments include corresponding computer systems, apparatus, and computer programs recorded on one or more computer storage devices, each configured to perform the actions of a method.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram showing an example of a computing environment that provides contextually grounded recommendations using a large language model (LLM) according to certain embodiments.

FIG. 2 is a flowchart of an example of a process for providing contextually grounded recommendations using an LLM according to certain embodiments.

FIG. 3 is a diagram showing an example of using a graph to train an LLM with respect to the product dependencies in a computing system for providing contextually grounded recommendations using an LLM according to certain embodiments.

FIG. 4 is a diagram showing an example of verbalization and fine tuning in a computing system for providing contextually grounded recommendations using an LLM according to certain embodiments.

FIG. 5 is a diagram showing an example of contextual grounding and scoring in a computing system for providing recommendations using an LLM according to certain embodiments.

FIG. 6 is a flowchart of another example of a process for providing contextually grounded recommendations using an LLM according to certain embodiments.

FIG. 7 is a block diagram of an example of a computing system architecture for providing contextually grounded recommendations using an LLM according to certain embodiments.

FIG. 8 is an example of a screenshot generated by a computing system for providing contextually grounded recommendations using an LLM according to certain embodiments.

FIG. 9 is a diagram of an example of a computing system that provides contextually grounded recommendations according to certain embodiments.

### DETAILED DESCRIPTION

Personnel connected with managing a business, service, manufacturing environment, or complex systems need to prioritize their efforts to focus first on the most valuable opportunities for improvement. Often, such users have access to research data pertaining to a system. In a larger enterprise, this data may be available from a research department or division within the enterprise. In a smaller one, this data may be available from third parties. Such users and/or their support staff can analyze this data, either manually, or with statistical tools, in order to determine the best course.

To make informed decisions on sequences of actions to take for a given system, users may conduct a comprehensive analysis of system attributes, behaviors, and targets. For such an analysis to be successful, an understanding of the diverse range of possibilities and familiarity with the available strategies are required. Unfortunately, the process of building up this expertise is slow, and the most effective results still often only come after substantial trial and error. Generic AI-based solutions are available and can provide users with tailored steps to take for each unique scenario, however, these models lack industry-unique context and often produce results only marginally better than those achieved with traditional tools and techniques.

Embodiments described herein address the above issues by providing a model architecture that can ingest historical system data. For example, in a business or manufacturing context, this data may come from sources such as emails, meeting notes, and business records. In a manufacturing environment, task specific data on efficiency, power consumption, errors, and the like with respect to machines used in the manufacturing process may provide historical system data. Such data in a software development environment may include historical data in the form of memory usage, CPU statistics, and latency. A model according to certain embodiments can comprehend nuanced context from this unstructured data that would be invisible to rules-based AI. The model architecture can understand, needs, challenges, organizational structure, and relationships based on language analysis.

For example, an analytics application is executed on a computing system and can provide contextually grounded recommendations using a large language model (LLM) according to certain embodiments described herein. The analytics application receives domain specific data for a simulation and transforms the domain specific data into a labeled, natural language description of the domain specific data. The analytics application provides the labeled, natural language description and a classification task prompt with interaction history to the LLM to generate a contextually enhanced LLM configured to produce context-aware output. The analytics application then outputs, using the contextually enhanced LLM, an interactive list of scored actions corresponding to the simulation. A recommended action may be generated based at least in part on the interactive list of scored actions, perhaps making use of input provided through a user interface. A sequence of actions may be produced from recommended actions, and this sequence may be stored or displayed, and can be used to control a piece of equipment, optimize software, or to direct a business activity.

In some account-based marketing examples, domain specific data includes product descriptions, account data, and product dependencies. For controlling manufacturing equipment such as a robot, domain specific data may include data collected from sensors and interaction history of the robot. In a software optimization context, domain specific data may include execution trace data, memory usage history, CPU usage history, etc. In some examples, the analytics application defines nodes of a graph, wherein each node represents a product corresponding to one or more of the product descriptions. The analytics application can also define edges of the graph, where each edge represents an action corresponding to a relationship between products represented by the nodes between which the edge is defined. The graph can be used to train the LLM with respect to the product dependencies.

In some examples, the LLM can be pretrained by providing system data to a conditional, tabular generative adversarial network (CTGAN) and transforming an output of the CTGAN to produce a semantically-based textual description of labeled, tabular data based on the system data. The semantically-based textual description of labeled, tabular data can be used to pretrain the LLM. Synthetic data may be used to produce an expanded dataset for training purposes.

The use of a contextually enhanced LLM prevents the LLM from “hallucinating” or generating irrelevant predictions. By incorporating the data from the specific domain, the LLM's predictions become more grounded and relevant to the specific scenario, leading to more accurate and context-aware recommendations. The model architecture can ingest both structured and unstructured data, including action strategies, product descriptions, and system attributes. This capability allows the model to generate recommendations based on the synthesis of diverse data sources. In particular, the capability to process unstructured text data provides unique generalization, as the model can handle novel scenarios, strategies, and products without pre-defined labels.

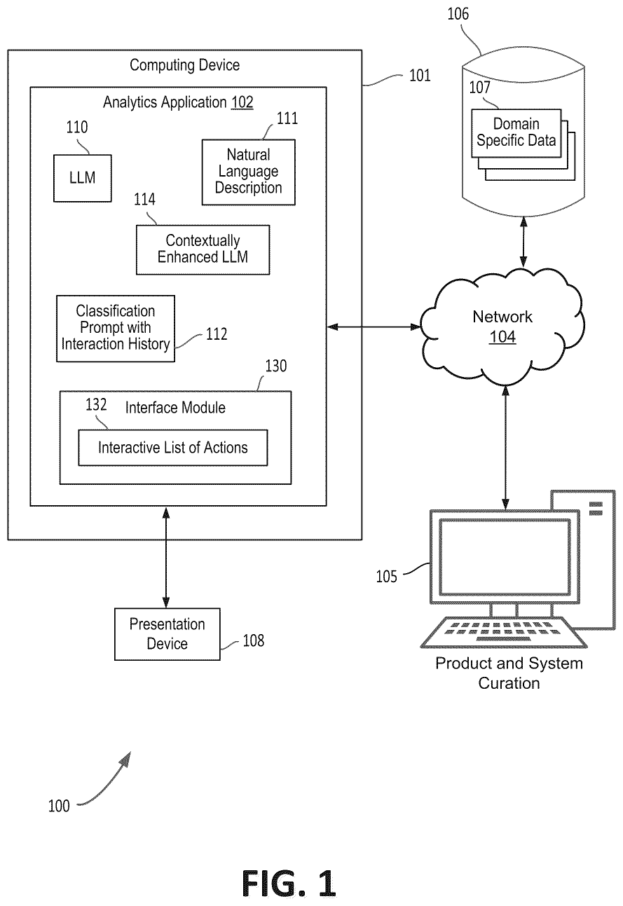

FIG. 1 is a diagram showing an example 100 of a computing environment that provides contextually grounded recommendations using a large language model (LLM) according to certain embodiments. The computing environment 100 includes a computing device 101 that executes an analytics application 102, a workstation 105 for product and system curation, and a presentation device 108 that is controlled based on the analytics application 102. The computing environment 100 also includes a database 106 of domain specific data 107. Workstation 105 and database 106 are communicatively coupled to computing device 101 using network 104. While a simulation is in process and/or when the simulation has been completed, results can be displayed on presentation device 108.

Still referring to FIG. 1, in this example, the analytics application 102 includes the LLM 110 and the labeled, natural language description 111 of the domain specific data 107 for provision to the LLM. A classification task prompt with interaction history 112 is also provided to the LLM 110. The labeled, natural language description 111 and the classification prompt with interaction history are both provided to LLM 110 in order to produce a contextually enhanced LLM 114. The analytics application 102 in this example includes and interface module 130. A list of scored actions 132 can be provided using the interface model 130 and displayed on presentation device 108. This display may be interactive in nature so that the interface model 130 can received input to initiate a simulation, or to change parameters and rerun the simulation.

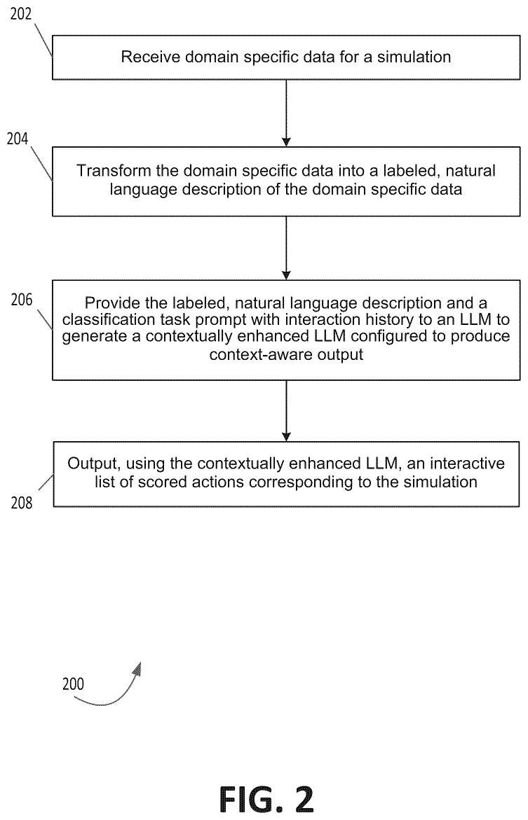

FIG. 2 is a flowchart of an example process 200 for providing contextually grounded recommendations using an LLM according to certain embodiments. In this example, a computing device carries out the process by executing suitable program code, for example, computer program code for an application, such as analytics application 102. In a practical application, administrators of a software tool such as analytics application 102 may pretrain an LLM and over time refine the choice of possible actions that can be simulated and projected, replacing outdated actions with newer ones.

At block 202, in order to run a simulation, the computing device receives domain specific data for the simulation. For purposes of an example of directed to account-based marketing, an account is treated as a system and the simulation may be directed at scoring various sales plays or recommendations for specific actions to implement a sales play for various products. There are other simulations where characterizing products of a business may be relevant, for example, manufacturing and distribution. Another example is generating recommendations for sequences of actions to be taken by autonomous robots operating in a dynamic, unstructured environments, for instance, a warehouse, and software optimization for suggest improvements to critical sections, memory usage and algorithms. A further example is software optimization, where a system monitors software execution, collecting metrics like CPU usage, memory consumption, and function latency while analysing data like code, documentation and execution traces to suggest improvements.

At block 204 of FIG. 2, the computing device transforms the domain specific data into a labeled, natural language description of the domain specific data for use in the simulation, for example, natural language description 111. At block 206, the computing device provides the labeled, natural language description to an LLM. A classification task prompt with interaction history is also provided to the LLM. A classification task prompt is an event that causes a classification task to be implemented. The classification task assigns a class or category to a snippet of text. The description and the classification task prompt are processed by the LLM to generate a contextually enhanced LLM configured to produce context-aware output, such as contextually enhanced LLM 114. At block 208, the computing device outputs, using the contextually enhanced LLM, an interactive list of scored actions corresponding to the simulation. This list of scored actions can be output using interface module 130 of analytics application 102 and may be displayed on presentation device 108.

A recommended action may be generated based at least in part on the interactive list of scored actions, perhaps making use of input provided through a user interface. A sequence of actions may be produced from recommended actions, and this sequence may be stored or displayed, and can be used to control a piece of equipment, optimize software, or to direct a business activity. In robotics, a software application can leverage an LLM to generate context-aware recommendations for autonomous robots operating in a dynamic, unstructured environments, for instance, a warehouse. The LLM can first be further pre-trained (or fine tuned) on broad textual descriptions of the environment, and tasks. The computing system can then collect real-time data from the robot's sensors and maintain an interaction history. The computing system can convert task-specific data into a labeled, natural language description and provide a classification task prompt to the LLM. The LLM processes the data, and can generate context-aware recommendations for the robot's actions. These recommendations can include operations that optimize the robot's path, speed, and movement pattern to minimize travel time, conserve energy, and avoid obstacles. The robot can execute the recommended sequence of actions, leading to improved operational performance and adaptability through continuous learning and adaptation based on evolving data. Such an application can enhance warehouse logistics, reduces costs, and ensures efficient operations in dynamic warehouse settings. In this manner, the technique enables the robot to solve decision-making tasks using both, (1) historical policy data, which provides interaction replay from the environment, and (2) semantic descriptions of the environment and tasks that provide analytical understanding aiding the model's reasoning.

A computing system can also monitor software execution, collecting metrics like CPU usage, memory consumption, and function latency while analyzing data like code, documentation and execution traces to suggest improvements to critical sections, memory usage, algorithms, etc. that improve speed and efficiency. The computing system can convert observed data into natural language insights that characterize performance issues, such as, “Function X causes high memory usage due to temporary objects,” along with semantic descriptions of programming and hardware concepts (e.g., from texts). These semantic descriptions can be combined with source code, documentation, and architectures and fed to an LLM tuned on software optimization tasks. The model can then suggest targeted improvements based on its contextual understanding, such as, “Introduce a caching mechanism for function X to improve performance.” The computing system could recommend introducing memoization, improving memory allocation, parallelizing processing, or using faster algorithms. By linking runtime profiles with code context via natural language, the technique can automatically recommend optimizations to improve software speed and efficiency without extensive manual effort.

In some examples, simulations for a system of interactions and parameters that define an account when the analytics application is used for account-based marketing can be carried out by a computing system as described herein, with recommendations resulting from a simulation including sales plays and actions to carry out the sales plays. Such ways of carrying out the sales plays may include, as examples, one or more of messaging, meetings, or presentations. It should be noted that a system to be characterized for simulation purposes will be referred to herein as a “system” while a computing system that executes the analytics application and the LLM will be referred to as a “computing system” or a “computer system.”

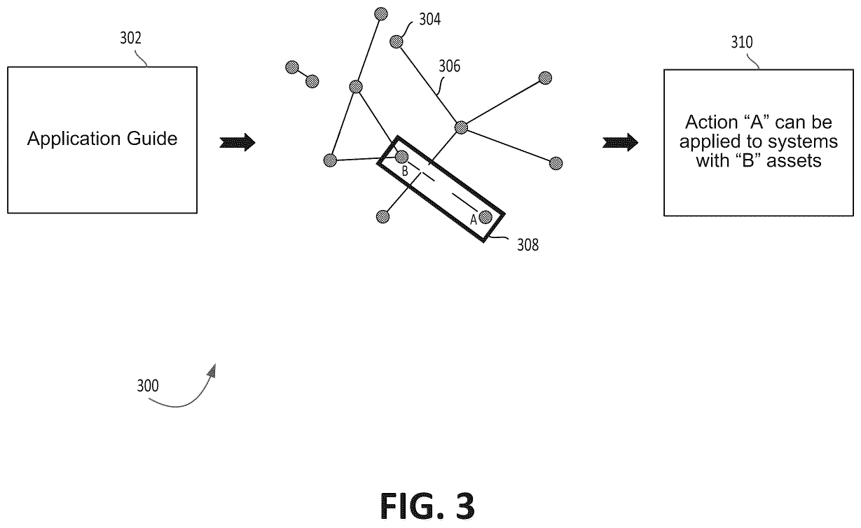

To provide the LLM with relevant context, domain-specific data can be obtained from documents, which describe products and services for an account, including dependencies among those products and services. This enriched context helps the LLM to better understand industry-specific jargon and tailor sales play predictions accordingly. FIG. 3 is a diagram showing an example 300 of using a graph to train an LLM with respect to the product dependencies in a computing system for providing contextually grounded recommendations using an LLM according to certain embodiments. The product dependencies are an example of domain specific data. The domain in this example may be a manufacturing, sales, or service domain.

In the example of FIG. 3, dependencies are determined using an “application guide” 302. In order to fine tune the LLM, product dependencies from the application guide are graphed. The analytics application can define nodes 304 of the graph. Each node represents a product corresponding to one or more of the product descriptions in the application guide. The analytics application can then define edges 306 of the graph. Each edge represents an action that can be taken by users of the system. Each action corresponds to a relationship between products represented by the nodes between which the respective edge is defined.

Staying with FIG. 3, the graph can be used to train the LLM with respect to the product dependencies. This training may include fine tuning the LLM using tabular data derived from the graph described above, as well as from data derived from account information. Verbalization can be used to transform the tabular data to natural language text. By training the LLM on this labeled and contextually enriched data, the LLM can be taught intricate patterns and associations between account characteristics and recommended actions, such as sales plays. As one example of such a recommended action, a pair 308 of nodes representing products can be used to define an action 310, namely that an action A can be applied to systems (accounts) with product assets B.

Note that a similar graph can be used in other contexts, for example nodes could define weather or climate phenomena and edges could define the relationship between those phenomena. In robotics, where the LLM processes the data, and generates context-aware recommendations for a robot's actions, the nodes can represent positions of actuators and the edges can represent relationships in the form of movements between those positions. In a software optimization context, nodes can represent various states and edges can represent relationships between those.

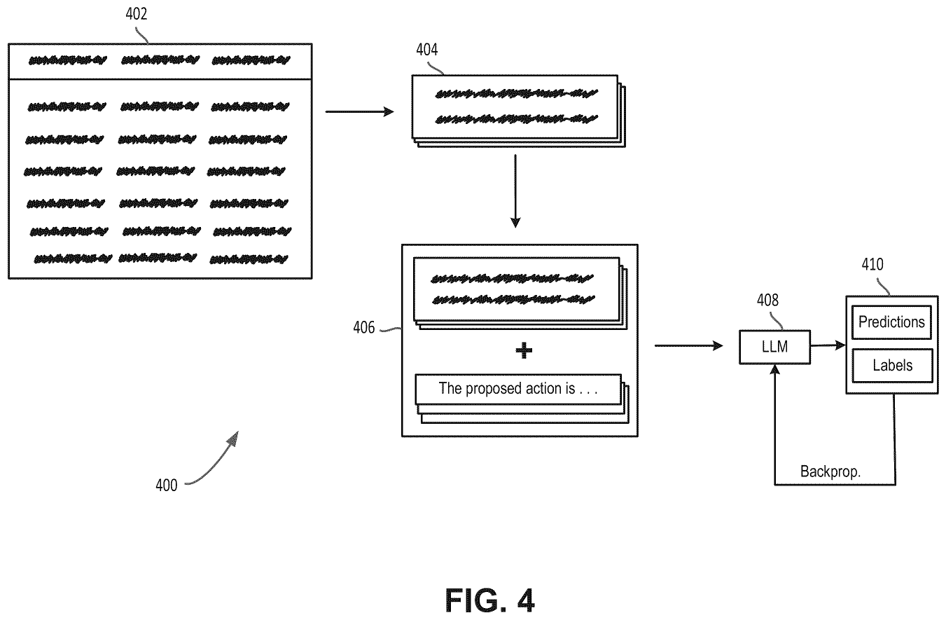

FIG. 4 is a diagram showing an example 400 of verbalization and fine tuning mentioned above in a computing system for providing contextually grounded recommendations using an LLM according to certain embodiments. Example 400 includes system attributes and interaction history organized in table 402. This table can be transformed into labeled, natural language descriptions 404 of the domain specific data using verbalization. These descriptions can be used to provide a natural language description and a classification task prompt with interaction history to the LLM. In this example, the natural language description and prompt is provided by using a task-specific prompt appended to a description to produce labeled data as concatenated question-answer pairs 406. This labeled data is provided to LLM 408, which produces labeled predictions 410, which are then backpropagated to LLM 408 to fine tune the LLM and produce the contextually enhanced LLM, for example, contextually enhanced LLM 114.

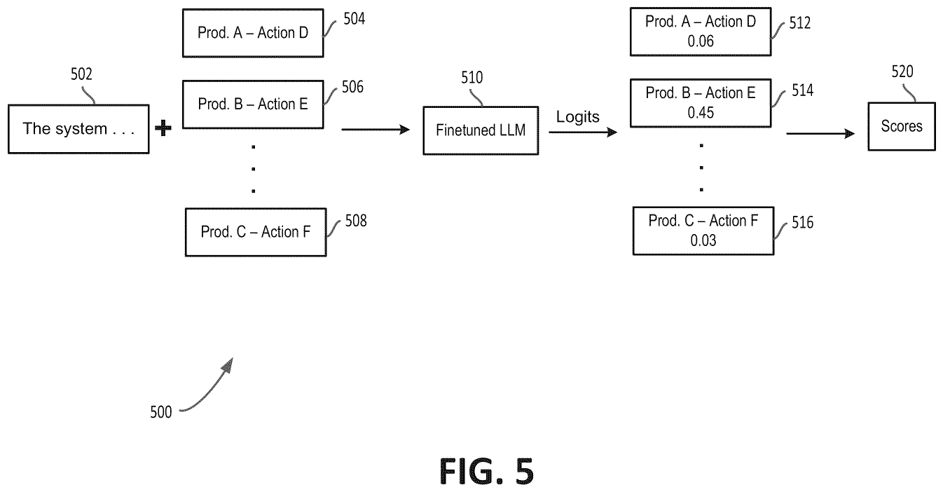

FIG. 5 is a diagram showing an example 500 of contextual grounding and scoring in a computing system for providing recommendations using an LLM according to certain embodiments. The score for a candidate answer can be obtained using the product of softmaxed logits. The softmax function is a normalized exponential function that converts a vector of K real numbers into a probability distribution of K possible outcomes. This process ensures that the LLM considers the context of the question when generating answers and avoids generating answers that are inconsistent or unrelated. Prompt 502 is from the labeled data generated in FIG. 4 from the verbalized data. If the system involved in the simulation is an account and the action is a sales play, the prompt may be, as an example, a combination of a description of a characteristic of the account, such as one beginning with, “The account has,” and a description of a sales play, such as one beginning with, “The proposed sales play is.” This technique provides contextually enriched input for the LLM, ensuring that it considers the proposed sales play context before generating predictions. Various actions for the simulation include action 504, action D pertaining to product A, action 506, action B pertaining to product E, and action 508, action F pertaining to product C. These prompts are provided to fine tuned LLM 510.

Words or sentences in each prompt can be broken into tokens, which may be parts of words or sentences, individual words, or syllables. The tokens pass through the layers of the LLM. The LLM works regressively. It finds the next most probable token, adds it, computes the next most probable token, and continues. With access to each individual probability vector of the tokens, the probability of each token that can occur can be computed. For a sales play problem, each sales play that needs to be predicted is split into tokens, the probability of each token occurring next is computed, and the tokens are aggregated to determine the score indicating the probability of the whole sales play. The LLM computes the probability over the entire space of all available tokens. However, if there is a finite number of recommendations to be made, as would be the case in a sales play simulation, probabilities of tokens only need to be computed for each of those finite number of possible recommendations.

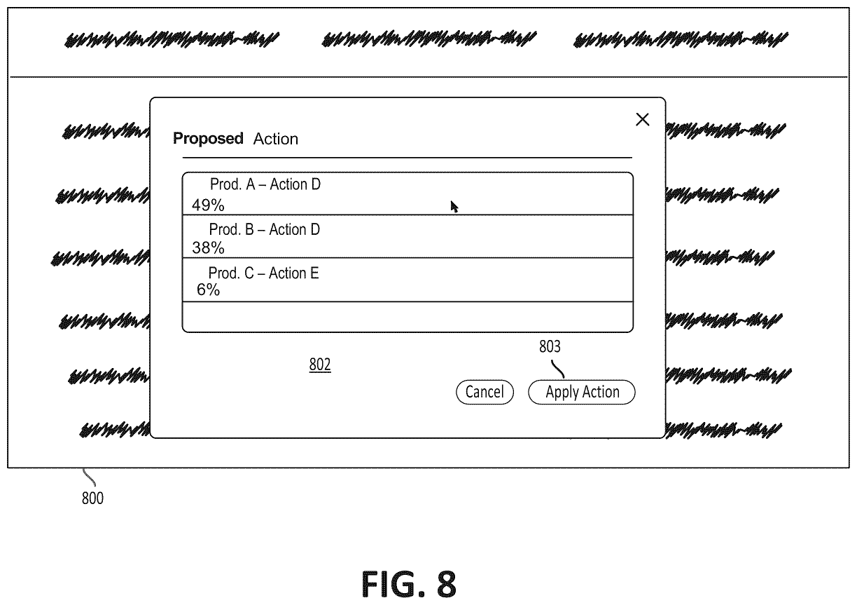

Continuing with FIG. 5, unnormalized final scores (logits) for each token are produced by the model, and these are used to compute scores for individual actions, for example, sales plays or ways of implementing the sales play. A logit represents the probability of a specified token coming after another token. For example, score 512 corresponds to action (sales play) 504, score 514 corresponding to action 506, and score 516 corresponding to action 508. These scores are assembled to produce an interactive list 520 of scored actions corresponding to the simulation. Data behind the interactive list can be accessed through a user interface (UI), changes to the actions in the simulation can be made, and the simulation can be run again. This display will be described in more detail below with respect to FIG. 8.

In a sales play simulation, the model architecture can predict sales missed. When a company is involved, firmographic information of that company can be used. The products and services that company is currently subscribed to and their relationships to current offerings can also be used to project what sales plays or actions would be most successful.

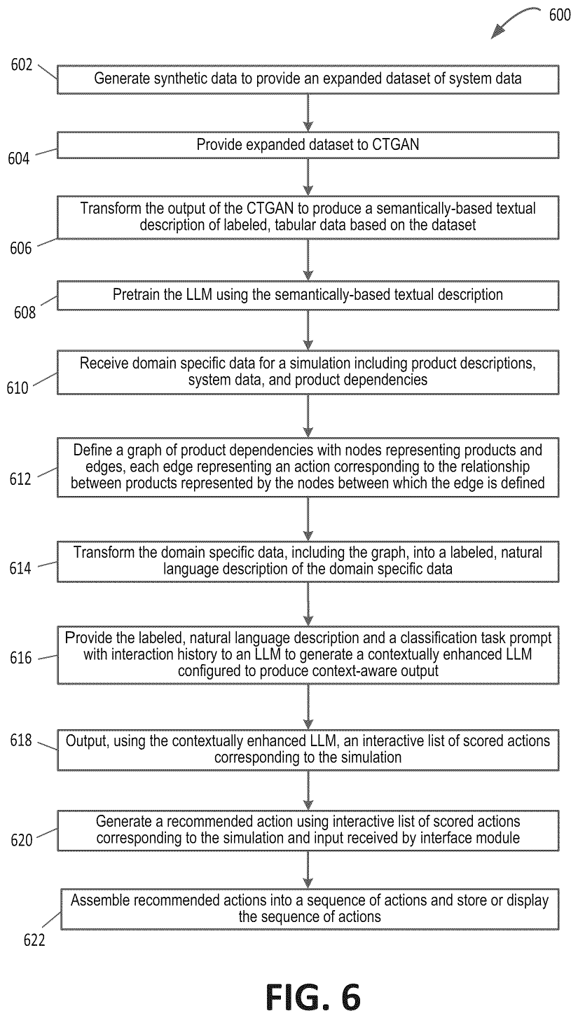

FIG. 6 is a flowchart of another example of a process 600 for providing contextually grounded recommendations using an LLM according to certain embodiments. In this example, one or more computing devices carry out the process by executing suitable program code. For example, computing device 101 may carry out the process by executing analytics application 102.

At block 602 of process 600, the computing device generates synthetic data to provide an expanded dataset of system data for training purposes. A synthetic data vault conditional tabular GAN (SDV-CTGAN) can be used. At block 604, the computing device provides an expanded dataset to a conditional, tabular generative adversarial network (CTGAN). At block 606, the computing device transforms the output of the CTGAN to produce a semantically-based textual description of labeled, tabular data based on the expanded dataset. GANs are generative models that learn distributions of data, and once a GAN learns distributions of the data, newer data can be sampled from the GAN's distribution. At block 608, the LLM is pretrained using the semantically-based textual description.

To pretrain the LLM in a supervised way, labels can be generated by leveraging previous history for the system and its inputs, outputs, and/or users. In a sales play problem, the system modeled is an account and the users modeled are leads. By working backward and analyzing historical data, information on previous interactions can be gathered, resulting in a labeled dataset where each account is associated with a corresponding historical sales play.

In this example, to incorporate the labeled tabular data into an LLM for both pretraining and contextual enrichment as described below, the data is verbalized, meaning the structured tabular data is turned into text in order to take advantage of the LLM's natural language processing capabilities. This process involves mapping the tabular data into a natural language format by using a template and generating sentences that describe the activities, attributes, organization, etc., from the tabular data in a database or data store. In one example, during verbalization, a computing device retrieves the column names and values from a data table. For each column name, the computing device determines its semantic meaning and corresponding natural language phrase, and then combines the natural language phrases with their corresponding values to form a sentence. The computing device repeats this process for each row in the table to generate multiple sentences. Optionally, sentences can be concatenated to form paragraphs or other kinds of longer text blocks.

Continuing with FIG. 6, at block 610, the computing device receives the domain specific data for a simulation. For purposes of an example directed to account-based marketing, an account is treated as a system and the simulation may be directed at scoring various sales plays or recommendations for specific actions to implement a sales play for various products. Domain specific data in such cases can include product descriptions, account data, and product dependencies.

Product dependencies can be characterized for a simulation using a graph of nodes as discussed above with respect to FIG. 3, where products are represented by nodes 304 and dependencies are represented by edges 306. At block 612 of FIG. 6, the computing device defines a graph of product dependencies with nodes representing products and edges. Each edge in the graph represents an action corresponding to the relationship between products represented by the nodes between which the edge is defined. This graph becomes part of the domain specific data that is used to contextualize the LLM.

Staying with FIG. 6, at block 614, the computing device transforms the domain specific data, including the graph, into a labeled, natural language description of the domain specific data. At block 616, the computing device provides the labeled, natural language description, as well a classification task prompt with interaction history, to an LLM to generate a contextually enhanced LLM configured to produce context-aware output. At block 618, the computing device outputs, using the contextually enhanced LLM, an interactive list of scored actions corresponding to the simulation, in a manner similar to that described with respect to block 208 of FIG. 2. The functions included in block 612 through 616 and discussed with respect to FIG. 6 can be used in implementing a step for producing a contextually enhanced large language model (LLM) configured to produce context-aware output using the labeled, natural language description. At block 620 the computing device generates a recommended action using the interactive list of scored actions corresponding to the simulation. This recommended action may be in part based on input received by interface module, as users select an action or actions based on scores. At block 622, multiple recommended actions are assembled into a sequence of actions and the sequence of actions is displayed or stored.

In some embodiments, data inputs can be expanded to incorporate external signals like third-party intent data, for example, as provided by vendors that extract it from social media and/or other sources. By leveraging a model architecture that consumes tabular records, text corpora, and other heterogeneous data, the model architectures described herein can be made to provide even more robust recommendations adapted to evolving real-world situations. Rather than relying solely on historical training labels, a model architecture that takes advantage of external data can dynamically produce projections for new systems by evaluating the systems in the context of accumulated data.

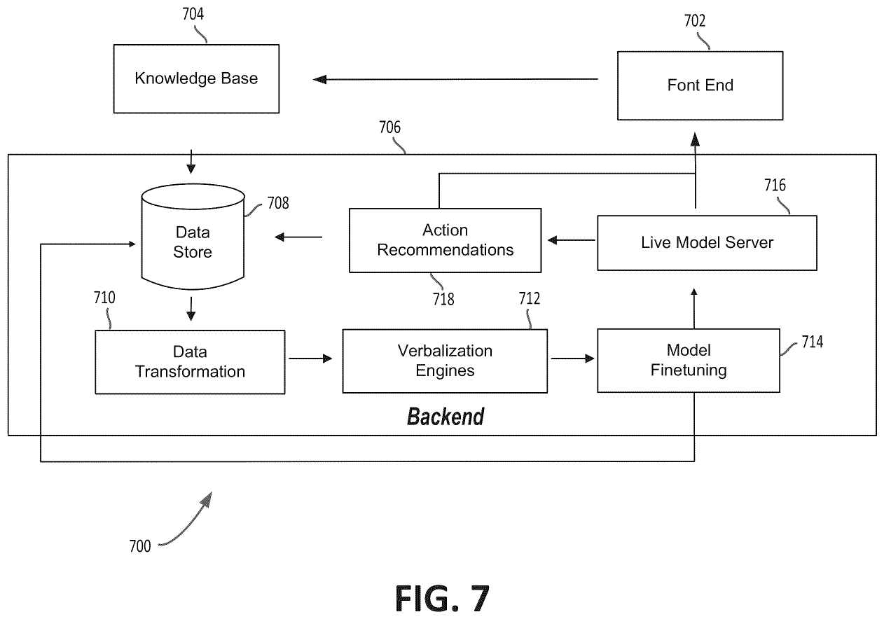

FIG. 7 is a block diagram of an example of a computing system architecture 700 for providing contextually grounded recommendations using an LLM according to certain embodiments. Front end 702 includes a user interface. For example, APIs build using a web framework may be presented to users as part of front end 702. Input for setting up a simulation and selecting actions may be received through these APIs and actions may be presented using these APIs. When a simulation is selected and initiated, domain specific data can be provided by the knowledge base 704. The remaining components of the computing system architecture 700 are part of backend 706.

Backend 706 in FIG. 7 includes a data store 708. Data store 708 caches data and output for simulations while they are being run and/or until a simulation is cleared so that another simulation can be initiated. Data transformation module 710 handles data extraction, data preprocessing, and data expansion. For example, data for the system(s) being studied can be extracted from a database or data processing platform and preprocessed by inserting missing values, removing duplicates, etc. Data types can be normalized and transformed, with relevant features and attributes selected. If the systems being studied are accounts, all personally identifiable information can be removed.

Data transformation module 710 of architecture 700 can also create synthetic data to expand a dataset used for training. For example, an SDV-CTGAN can be used to provide a larger dataset with data samples that are more representative of underlying data distributions than might otherwise be available with real system data. The model can learn the underlying data distribution from the original dataset and then generate synthetic data that mimics the characteristics and statistical properties of the original data. Once the model is trained, it can generate new synthetic data points that resemble the original data but introduce some level of diversity.

Continuing with FIG. 7, backend 706 also includes a verbalization engine module 712. Verbalization engine module transforms data into natural language text, as described herein with respect to labeled descriptions from domain specific data. Model fine tuning module 714 provides fine tuning to an LLM as described with respect to LLM 408 of FIG. 4 and LLM 510 of FIG. 5. Live model server 716 provides the simulation output and input to front end 702 and stores action recommendations 718 for provision to the front end for interactive display, as described below with respect to FIG. 8.

FIG. 8 is an example of a screenshot 800 generated by a computing system for providing contextually grounded recommendations using an LLM according to certain embodiments. Screenshot 800 includes a UI with rows and columns of data describing proposed actions for simulation. Once the simulation is run, these are displayed with the a score for each, as described above with respect to scores 512, 514, and 516 shown in FIG. 5. The UI can include multiple actions in a column entry where only one action is shown. The UI can display a symbol such as a disclosure triangle, plus sign, or other indicator if there is more than one scored action behind the entry. If selected, dialog box 802 is popped up with a selectable list of the actions, and the user can select whichever action is desired for the particular system, or combined with other selected actions to form a sequence of actions. Dialog box 802 displays these with scores. The selected action can be applied for the associated system. This display format allows users to gauge the confidence levels of each prediction. Within the dialog box, users have the option to select the desired action and upon selection and confirmation using the “apply action” button 803, the chosen action is presented in the confirmed action column of the UI shown in screenshot 800. This feature provides transparency and allows users to review a selection before finalizing a decision regarding a particular scored action.

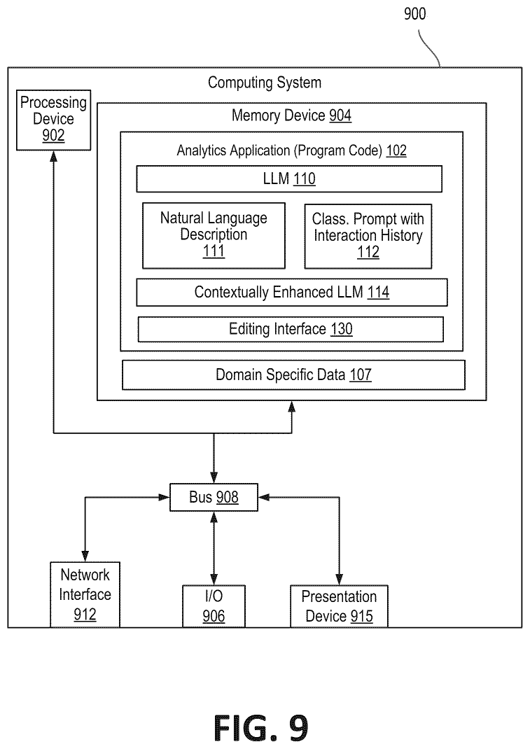

FIG. 9 is a diagram of an example of a computing system that provides contextually grounded recommendations according to certain embodiments. Computing system 900 includes a processing device 902 communicatively coupled to one or more memory devices. The processing device 902 executes computer-executable program code stored in the memory component 904. Examples of the processing device 902 include a microprocessor, an application-specific integrated circuit (“ASIC”), a field-programmable gate array (“FPGA”), or any other suitable processing device. The processing device 902 can include any number of processing devices, including a single processing device. The memory component 904 includes any suitable non-transitory computer-readable medium for storing data, program code instructions, or both. A computer-readable medium can include any electronic, optical, magnetic, or other storage device capable of providing a processor with computer-readable, executable instructions or other program code. The memory component can include multiple memory devices to provide a computer-readable medium. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, and JavaScript.

Still referring to FIG. 9, the computing system 900 may also include a number of external or internal devices, for example, input or output devices. For example, the computing system 900 is shown with one or more input/output (“I/O”) interfaces 906. An I/O interface 906 can receive input from input devices or provide output to output devices (not shown). Output may be provided using the interface module 130 of the analytics application 102. One or more buses 908 are also included in the computing system 900. A bus 908 communicatively couples one or more components of a respective one of the computing system 900. The processing device 902 executes program code that configures the computing system 900 to perform one or more of the operations described herein. The program code includes, for example, analytics application 102 or other suitable applications that perform one or more operations described herein. The program code may be resident in the memory component 904 or any suitable computer-readable medium and may be executed by the processing device 902 or any other suitable processor. Memory component 904, includes LLM 110, natural language description 111, classification prompt with interaction history 112, and contextually enhanced LLM 114.

The computing system 900 of FIG. 9 also includes a network interface device 912. The network interface device 912 includes any device or group of devices suitable for establishing a wired or wireless data connection to one or more data networks. Non-limiting examples of the network interface device 912 include an Ethernet network adapter, a wireless network adapter, and/or the like. The computing system 900 is able to communicate with one or more other computing devices (e.g., another computing device executing other software, not shown) via a data network (not shown) using the network interface device 912. Network interface device 912 can also be used to communicate with the database 106.

Staying with FIG. 9, in some embodiments, the computing system 900 also includes the presentation device 915. A presentation device 915 can include any device or group of devices suitable for providing visual, auditory, or other suitable sensory output. In examples, presentation device 915 provides the dynamic display of scored actions using a contextually-grounded LLM. Non-limiting examples of the presentation device 915 include a touchscreen, a monitor, a separate mobile computing device, etc. In some aspects, the presentation device 915 can include a remote client-computing device that communicates with the computing system 900 using one or more data networks. Computing system 900 may be implemented as a unitary computing device, for example, a notebook or mobile computer. Alternatively, as an example, the various devices included in computing system 900 may be distributed and interconnected by interfaces or a network with a central or main computing device including one or more processors.

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied-for example, blocks can be re-ordered, combined, and/or broken into sub-blocks. Certain blocks or processes can be performed in parallel.

The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
receiving domain specific data for a simulation;
transforming the domain specific data into a labeled, natural language description of the domain specific data for the simulation;
providing the labeled, natural language description and a classification task prompt with interaction history to a large language model (LLM) to generate a contextually enhanced LLM configured to produce context-aware output; and
outputting, using the contextually enhanced LLM, an interactive list of scored actions corresponding to the simulation.

2. The method of claim 1, further comprising:
generating a recommended action based at least in part on the interactive list of scored actions corresponding to the simulation;
assembling a plurality of recommended actions into a sequence of actions; and
storing or displaying the sequence of actions.

3. The method of claim 1, wherein the classification task prompt with interaction history comprises concatenated question-answer pairs.

4. The method of claim 1, wherein the domain specific data includes product descriptions, system data, and product dependencies.

5. The method of claim 4, further comprising:
defining a plurality of nodes of a graph, wherein each node represents a product corresponding to one or more of the product descriptions;
defining edges of the graph, each edge representing an action corresponding to a relationship between products represented by the nodes from the plurality of nodes between which the edge is defined; and
using the graph to train the LLM with respect to the product dependencies.

6. The method of claim 1, further comprising:
providing system data to a conditional, tabular generative adversarial network (CTGAN);
transforming an output of the CTGAN to produce a semantically-based textual description of labeled, tabular data based on the system data; and
pretraining the LLM using the semantically-based textual description of labeled, tabular data.

7. The method of claim 6, further comprising:
generating synthetic data to produce an expanded dataset including the system data; and
providing the expanded dataset to the CTGAN so that the semantically-based textual description of labeled, tabular data is based on the expanded dataset.

8. A computing system comprising:
a memory component; and
a processing device coupled to the memory component, the processing device to perform operations comprising:
transforming domain specific data into a labeled, natural language description of the domain specific data for a simulation;
providing the labeled, natural language description and a classification task prompt with interaction history to a large language model (LLM) to generate a contextually enhanced LLM configured to produce context-aware output; and
outputting, using the contextually enhanced LLM, an interactive list of scored actions corresponding to the simulation.

9. The computing system of claim 8, wherein the operations further comprise:
generating a recommended action based at least in part on the interactive list of scored actions corresponding to the simulation;
assembling a plurality of recommended actions into a sequence of actions; and
storing or displaying the sequence of actions.

10. The computing system of claim 8, wherein the classification task prompt with interaction history comprises concatenated question-answer pairs.

11. The computing system of claim 8, wherein the domain specific data includes product descriptions, system data, and product dependencies.

12. The computing system of claim 11, wherein the operations further comprise:
defining a plurality of nodes of a graph, wherein each node represents a product corresponding to one or more of the product descriptions;
defining edges of the graph, each edge representing an action corresponding to a relationship between products represented by the nodes from the plurality of nodes between which the edge is defined; and
using the graph to train the LLM with respect to the product dependencies.

13. The computing system of claim 8, wherein the operations further comprise:
providing system data to a conditional, tabular generative adversarial network (CTGAN);
transforming an output of the CTGAN to produce a semantically-based textual description of labeled, tabular data based on the system data; and
pretraining the LLM using the semantically-based textual description of labeled, tabular data.

14. The computing system of claim 13, wherein the operations further comprise:
generating synthetic data to produce an expanded dataset including the system data; and
providing the expanded dataset to the CTGAN so that the semantically-based textual description of labeled, tabular data is based on the expanded dataset.

15. A non-transitory computer-readable medium storing executable instructions, which when executed by a processing device, cause the processing device to perform operations comprising:
receiving domain specific data for a simulation;
transforming the domain specific data into a labeled, natural language description of the domain specific data for the simulation;
a step for producing a contextually enhanced large language model (LLM) configured to produce context-aware output using the labeled, natural language description; and
outputting, using the contextually enhanced LLM, an interactive list of scored actions corresponding to the simulation.

16. The non-transitory computer-readable medium of claim 15, wherein the operations further comprise:
generating a recommended action based at least in part on the interactive list of scored actions corresponding to the simulation;
assembling a plurality of recommended actions into a sequence of actions; and
storing or displaying the sequence of actions.

17. The non-transitory computer-readable medium of claim 15, wherein the domain specific data includes product descriptions, system data, and product dependencies.

18. The non-transitory computer-readable medium of claim 17, wherein the operations further comprise:
defining a plurality of nodes of a graph, wherein each node represents a product corresponding to one or more of the product descriptions;
defining edges of the graph, each edge representing an action corresponding to a relationship between products represented by the nodes from the plurality of nodes between which the edge is defined; and
using the graph to train the LLM with respect to the product dependencies.

19. The non-transitory computer-readable medium of claim 15, wherein the operations further comprise:
providing system data to a conditional, tabular generative adversarial network (CTGAN);
transforming an output of the CTGAN to produce a semantically-based textual description of labeled, tabular data based on the system data; and
pretraining the LLM using the semantically-based textual description of labeled, tabular data.

20. The non-transitory computer-readable medium of claim 19, wherein the operations further comprise:
generating synthetic data to produce an expanded dataset including the system data; and providing the expanded dataset to the CTGAN so that the semantically-based textual description of labeled, tabular data is based on the expanded dataset.
